(19) United States
(12) Patent Application Publication
(10) Pub. No.: US 2016/0125817 A1
(43) Pub. Date: May 5, 2016

(54) VIDEO PROCESSING CIRCUIT, VIDEO PROCESSING METHOD, ELECTRO-OPTICAL DEVICE AND ELECTRONIC APPARATUS

(71) Applicant: Seiko Epson Corporation, Tokyo (JP)

(72) Inventors: Kazuhisa Mizusako, Shiojiri-shi (JP); Hiroyuki Hosaka, Matsumoto-shi (JP)

(21) Appl. No.: 14/887,402

(22) Filed: Oct. 20, 2015

(30) Foreign Application Priority Data
Oct. 31, 2014 (JP) 2014-222472

(51) Int. Cl. G09G 3/34; G09G 3/36; H04N 13/04

(52) U.S. Cl. CPC G09G 3/3406; H04N 13/0486; G09G 3/3648; G09G 2310/08

(57) ABSTRACT

A video processing circuit includes a specific unit that specifies a first pixel adjacent to a second pixel which displays a higher gradation than a predetermined gradation, among the first pixels which display gradations equal to or lower than the predetermined gradation, based on the video signal in a current frame; a determination unit that determines whether or not the second pixel exists in a frame adjacent to the current frame on the time axis, in a position of the first pixel which is specified; and a correction unit that, in a case in which it is determined that the second pixel exists in the frame adjacent to the current frame, corrects the video signal in the current frame, in such a manner that a difference of an application voltage between the specified first pixel and the second pixel adjacent to the first pixel is reduced.

### BACKGROUND

1. Technical Field

The present invention relates to a technology that suppresses generation of display abnormality which is generated by alignment failure of a liquid crystal.

2. Related Art

A liquid crystal panel is configured to include a liquid crystal interposed between a pixel electrode provided in each pixel and a common electrode commonly provided in a plurality of pixels. In the liquid crystal panel, alignment failure (reverse tilt domain) of the liquid crystal due to a horizontal electric field which is generated between pixel electrodes adjacent to each other is generated, and this may cause generation of display abnormality. A technology that suppresses the generation of this type of display abnormality is disclosed in, for example, JP-A-2013-152483, JP-A-2011-53390, and JP-A-2013-156409. JP-A-2013-152483 discloses a technology that, in a case in which a boundary between a dark pixel and a bright pixel is detected and an application voltage to a dark pixel in contact with the detected boundary is lower than a voltage Vc, replaces the application voltage to the dark pixel with the voltage Vc. JP-A-2011-53390 discloses a technology that corrects an application voltage designated to a dark pixel in contact with a portion which is changed from a boundary detected in a frame before one frame of the current frame, among boundaries between dark pixels and bright pixels which are detected in the current frame. JP-A-2013-156409 discloses a technology that detects a boundary which is changed across the current frame from a frame before one frame of the current frame, among boundaries between dark pixels and bright pixels which are detected in the current frame, and corrects an application voltage designated to a pixel in contact with the changed boundary, to voltages different from each other in a partial period and the other periods of one frame period.

For example, in a case in which a video in which a display unit with a high gradation of white or close to white is disposed is displayed with respect to a background section with a low gradation of black or close to black like subtitle display in movies, display abnormality which will be described below may be generated due to a reverse tilt domain.

FIG. 21A is a diagram illustrating a display example of a 3D video made by a frame sequential method. A figure on the left side of FIG. 21A illustrates a left eye image which is viewed to the left eye of a user, and a figure on the right side illustrates a right eye image which is viewed to the right eye of the user. In order to give parallax to the user, the right eye image is configured by an image in which the left eye image is moved in a horizontal direction (right direction in the figure). A dashed line section illustrated in a figure on the right side of FIG. 21A indicates a position in which a display section of the left eye image exists. Here, in a case in which a reverse tilt domain is generated along the right side of the display section among boundaries between the background section and the display section, a video illustrated in FIG. 21B is viewed to the user. That is, in a portion which is a portion of the display section of the right eye image and in which the right side of the display section of the left eye image exists, a black linear (streaky) image is viewed to the user as an afterimage. Hereinafter, the reverse tilt domain that causes the display abnormality will be referred to as “afterimage domain”. For example, in a case in which the display section forms a character, a linear image that has a color of black or close to black and is formed along an edge of the character with white or close to white may be viewed.

### SUMMARY

An advantage of some aspects of the invention is to suppress generation of a reverse tilt domain that causes display abnormality in which an image with a low gradation is viewed in a portion of a region with a high gradation.

According to an aspect of the invention, there is provided a video processing circuit that defines a gradation which is displayed in each of a plurality of pixels, based on a video signal which designates an application voltage to the respective pixels of an optical modulator including the plurality of pixels, including: a specific unit that specifies a first pixel adjacent to a second pixel which displays a higher gradation than a predetermined gradation, among the first pixels which display gradations equal to or lower than the predetermined gradation, based on the video signal in a current frame; a determination unit that determines whether or not the second pixel exists in a frame adjacent to the current frame, in a position of the first pixel which is specified, based on the video signal of the frame adjacent to the current frame on the time axis; a correction unit that, in a case in which it is determined that the second pixel exists in the frame adjacent to the current frame, corrects the video signal in the current frame, in such a manner that a difference of an application voltage between the specified first pixel and the second pixel adjacent to the first pixel is reduced; and an output unit that outputs a signal according to the corrected video signal to a drive circuit which drives the optical modulator based on the signal.

According to the invention, it is possible to suppress generation of a reverse tilt domain that causes display abnormality in which an image with a low gradation is viewed in a portion of a region with a high gradation.

In the video processing circuit according to the aspect of the invention, the video signal may display a 3D video that alternately switches a left eye image and a right eye image in each frame, and the determination unit may determine whether or not the second pixel exists in a frame before one frame of the current frame, in a position of the specified first pixel.

According to the invention, in a case in which a 3D video in which a left eye image and a right eye image are alternately switched is displayed, it is possible to suppress generation of a reverse tilt domain that causes display abnormality in which an image with a low gradation is viewed in a portion of a region with a high gradation.

In the video processing circuit according to the aspect of the invention, the determination unit may determine whether or not the second pixel exists in a frame after one frame of the current frame, in a position of the specified first pixel.

According to the invention, the invention is not limited to a case in which a 3D video is displayed, it is possible to suppress generation of a reverse tilt domain that causes display abnormality in which an image with a low gradation is viewed in a portion of a region with a high gradation.

In the video processing circuit according to the aspect of the invention, the correction unit may set a pixel to which a lower application voltage that is designated by the video signal in the current frame is applied, among the specified first pixel and the second pixel adjacent to the first pixel, as a correction target.

According to the invention, it is possible to suppress an increase of the number of pixels which is a correction target, and to suppress generation of a reverse tilt domain.

In the video processing circuit according to the aspect of the invention, the correction unit may set the specified first pixel and the second pixel adjacent to the first pixel, as a correction target.

According to the invention, it is possible to reduce a change of the gradation of a pixel that is a correction target, and to suppress generation of a reverse tilt domain.

In the video processing circuit according to the aspect of the invention, the plurality of pixels may be provided in correspondence to each of intersections of a plurality of scan lines extending in a first direction and a plurality of data lines extending in a second direction, the drive circuit may select the plurality of scan lines on a per K (K is an integer equal to or greater than 2) piece basis, and apply a designated voltage to the pixel corresponding to one of the K scan lines, and in a case in which the specified first pixel and the second pixel adjacent to the first pixel are adjacent in the first direction, the correction unit may set P (however, P is a natural number equal to or greater than 2) pixels that are consecutive in the first direction from a boundary interposed between the first pixel and the second pixel as a correction target, and in a case in which the specified first pixel and the second pixel adjacent to the first pixel are adjacent in the second direction, the correction unit may set Q (however, Q is a natural number smaller than P) pixels that are consecutive in the second direction from the boundary as a correction target.

According to the invention, in a case in which scan lines are selected by multiple pieces and a voltage is applied to pixels, it is possible to suppress an unintentional increase of the number of pixels that is a correction target in a second direction, with respect to the number of pixels that is a correction target in a first direction.

In the video processing circuit according to the aspect of the invention, in a case in which two or more pixels that are consecutive in a direction separated from a boundary between the specified first pixel and the second pixel adjacent to the first pixel are set as a correction target, the correction unit may increase an amount of correction as much as the pixels close to the boundary.

According to the invention, it is possible to correct video signals of each pixel, in an amount of correction according to easy generation of a reverse tilt domain.

In the video processing circuit according to the aspect of the invention, the drive circuit may divide one frame into a plurality of fields, and apply a voltage according to the corrected video signal to the pixels in the respective fields that are divided, and the determination unit may determine whether or not the second pixel exists in a field closest to one field of the frame adjacent to the current frame on the time axis, in a position of the first pixel in one field of the current frame.

According to the invention, in a case in which one frame is divided into a plurality of fields and a voltage is applied to pixels, it is possible to suppress generation of a reverse tilt domain that causes display abnormality in which an image with a low gradation is viewed in a portion of a region with a high gradation.

In the video processing circuit according to the aspect of the invention, in a case in which the video signal indicates a 3D video in which a left eye image and a right eye image are alternately switched in each frame, the output unit may output a signal according to the corrected video signal to the drive circuit, in a case in which the video signal displays a 2D video, a third pixel adjacent to a fourth pixel to which the application voltage equal to or lower than the predetermined voltage is applied among the third pixels to which the application voltage higher than the predetermined voltage is applied may be specified based on the video signal in the current frame, and whether or not the fourth pixel exists in a frame before one frame of the current frame may be determined in a position of the specified third pixel based on the video signal in the frame before one frame of the current frame, in a case in which it is determined that the fourth pixel exists in the frame before one frame of the current frame, the video signal in the current frame may be corrected in such a manner that a difference of the application voltage between the specified third pixel and the fourth pixel adjacent to the third pixel is reduced, and a signal according to the corrected video signal may be output to the drive circuit.

According to the invention, in a case in which one of a 3D image and a 2D image is displayed, it is possible to suppress display abnormality that is caused by a reverse tilt domain.

The invention can be applied to not only a video processing circuit, but also a video processing method, an electro-optical device, and an electronic apparatus including the electro-optical device.

### BRIEF DESCRIPTION OF THE DRAWINGS

The invention will be described with reference to the accompanying drawings, wherein like numbers reference like elements.

FIG. 1 is a diagram illustrating the whole configuration of an electro-optical device according to a first embodiment of the invention.

FIG. 2 is a diagram illustrating equivalent circuits of pixels that are included in a liquid crystal panel according to the present embodiment.

FIG. 3 is an explanatory diagram of a display operation of a control circuit according to the present embodiment.

FIG. 4 is an explanatory diagram of a display example of both a left eye image L and a right eye image R according to the present embodiment.

FIG. 5 is a diagram illustrating V-T characteristics of the liquid crystal panel according to the present embodiment.

FIG. 6 is an explanatory diagram of a reverse tilt generation region.

FIG. 7 is a block diagram illustrating a configuration of a video processing circuit according to the present embodiment.

FIG. 8 is a flow chart illustrating video processing that is performed by the video processing circuit according to the present embodiment.

FIGS. 9A to 9C are explanatory diagrams of a specific example of the video processing that is performed by the video processing circuit according to the present embodiment.

FIGS. 10A and 10B are other explanatory diagrams of the specific example of the video processing that is performed by the video processing circuit according to the present embodiment.

FIG. 11 is an explanatory diagram of a display operation of a control circuit according to a second embodiment of the invention.

FIG. 12 is an explanatory diagram of the specific example of a display operation according to the present embodiment.

FIG. 13 is a still another explanatory diagram of the specific example of the video processing that is performed by the video processing circuit according to the present embodiment.

FIG. 14 is an explanatory diagram of a cause of the generation of a moving image domain.

FIG. 15 is a block diagram illustrating a configuration of a video processing circuit according to a third embodiment of the invention.

FIG. 16 is a flow chart illustrating video processing that is performed by the video processing circuit according to the present embodiment.

FIGS. 17A and 17B are explanatory diagrams of specific examples of the video processing that is performed by the video processing circuit according to the present embodiment.

FIG. 18 is an explanatory diagram of a specific example of video processing that is performed by a video processing circuit according to Modification Example 1 of the invention.

FIG. 19 is a diagram illustrating V-T characteristics of a liquid crystal panel according to Modification Example 3 of the invention.

FIG. 20 is a plan view illustrating a configuration of a projector to which an electro-optical device according to the invention is applied.

FIGS. 21A and 21B are explanatory diagrams of a cause of afterimage domain occurrence.

FIGS. 22A and 22B are explanatory diagrams of a problem of video processing in which a pixel of a correction target is determined based on a bright pixel.

FIG. 23 is an explanatory diagram of a problem of video processing in a case in which a plurality of data is simultaneously written.

### DESCRIPTION OF EXEMPLARY EMBODIMENTS

Hereinafter, embodiments of the invention will be described with reference to the drawings.

### First Embodiment

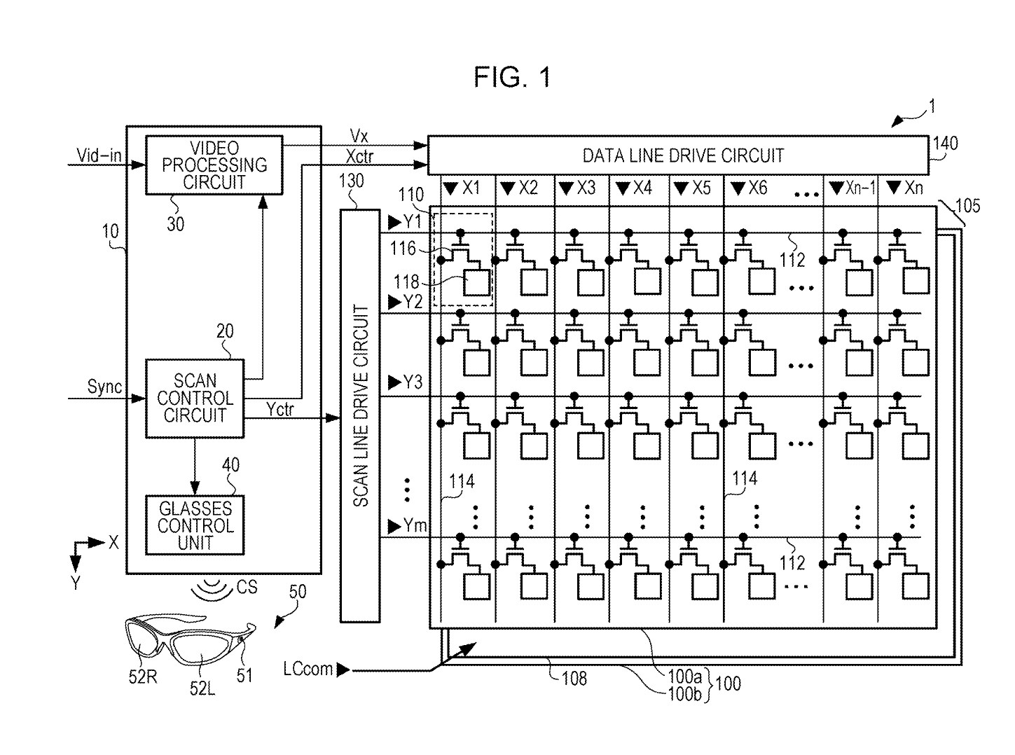

FIG. 1 is a block diagram illustrating the whole configuration of an electro-optical device 1 according to a first embodiment of the invention. The electro-optical device 1 displays a 3D video based on a frame sequential method, in such a manner that a user can perceive the 3D video in a state in which of wearing 3D glasses 50. As illustrated in FIG. 1, the electro-optical device 1 is a liquid crystal device that includes a control circuit 10, a liquid crystal panel 100, a scan line drive circuit 130, and a data line drive circuit 140.

An input video signal Vid-in is input to the control circuit 10 in synchronization with a synchronization signal Sync. The input video signal Vid-in is digital data that designates an application voltage to each pixel 110 which is included in the liquid crystal panel 100. The input video signal Vid-in is supplied in the sequence of scan in accordance with a vertical scan signal, a horizontal scan signal, and a dot clock signal (all the signals are not illustrated) that are included in the synchronization signal Sync.

The input video signal Vid-in is a signal that is supplied from, for example, a higher level device to the electro-optical device 1, and is obtained by converting a gradation signal indicating gradation values of each pixel. For example, the electro-optical device 1 performs predetermined processing such as gamma correction with respect to the gradation signal, and thereafter a conversion circuit that is not illustrated converts the signal into the input video signal Vid-in using a table that converts a gradation value into a voltage value.

However, in a case in which a voltage value of an application voltage that is designated to the pixel 110 is uniquely determined according to the gradation value, there is no problem to say that the input video signal Vid-in is a video signal that designates a gradation value to each pixel 110.

The control circuit 10 includes a scan control circuit 20, a video processing circuit 30, and a glasses control unit 40. The scan control circuit 20 generates various control signals, and controls each unit of the electro-optical device 1 in synchronization with the synchronization signal Sync. The video processing circuit 30 performs predetermined video processing with respect to the input video signal Vid-in, and outputs a data signal Vx for defining a gradation that is displayed on each of the plurality of pixels 110 in the liquid crystal panel 100. The data signal Vx is analog data that designates an application voltage to each pixel 110 in the liquid crystal panel 100.

The liquid crystal panel 100 corresponds to an optical converter that converts an incident light in response to a video signal. The liquid crystal panel 100 has a configuration in which an element substrate 100a and a counter substrate 100b are bonded to each other with a constant gap and a liquid crystal 105 that is driven by an electric field in a vertical direction is interposed in the gap. In the element substrate 100a, scan lines 112 of m rows are provided on a surface facing the counter substrate 100b so as to extend in the X (horizontal) direction (first direction), and meanwhile, data lines 114 of n columns extend in the Y (vertical) direction (second direction), and are provided so as to be electrically insulated to each scan line 112.

In the present embodiment, there is a case in which the scan lines 112 are referred to as a first row, a second row, a third row, . . . , and an mth row sequentially from top to bottom in the figure, in order to distinguish the scan lines 112. In the same manner, there is a case in which the data lines 114 are referred to as a first column, a second column, a third column, a fourth column, a fifth column, a sixth column, . . . , an (n−1)th column, and an nth column sequentially from left to right in the figure, in order to distinguish the data lines 114.

A set of an n channel type TFT 116 and a pixel electrode 118 with transparency and a rectangular shape is provided in an intersection of the scan lines 112 and the data lines 114 in the element substrate 100a. The gate electrode of the TFT 116 is connected to the scan lines 112, the source electrode of the TFT 116 is connected to the data lines 114, and the drain electrode of the TFT 116 is connected to the pixel electrode 118.

Meanwhile, the common electrode 108 with transparency is provided over the whole of the surface of the counter substrate 100b which faces the element substrate 100a. A voltage LCcom is applied to the common electrode 108 by a circuit that is not illustrated.

In FIG. 1, the counter surface of the element substrate 100a is the back side of paper, and thereby the scan lines 112, the data lines 114, the TFT 116, and the pixel electrode 118 which are provided on the counter surface of the element substrate have to be denoted by hidden lines (dashed lines), but those can be hardly seen, thereby being respectively denoted by solid lines.

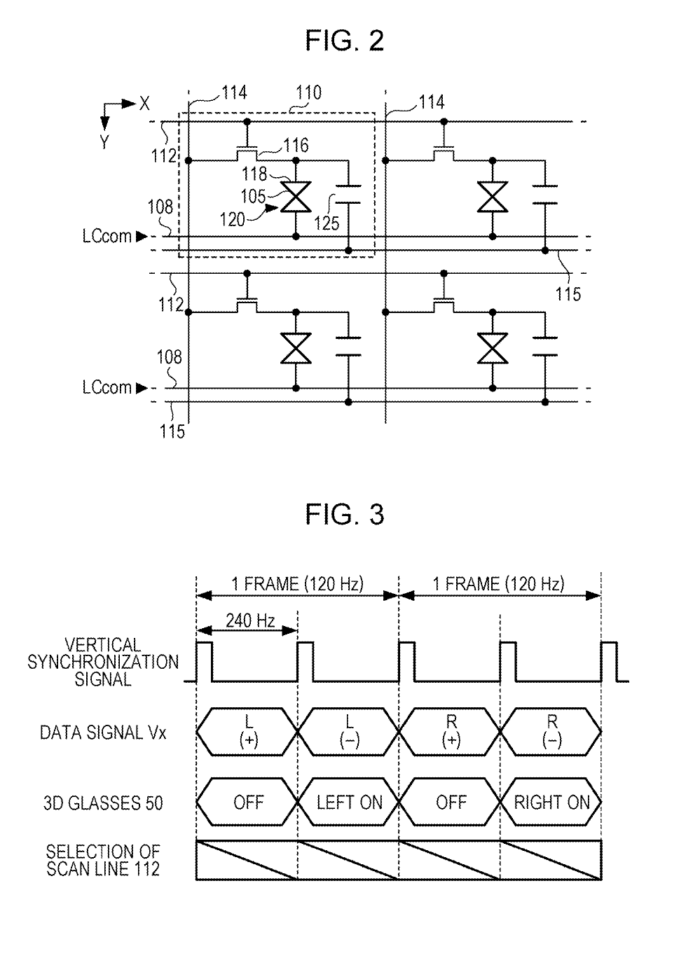

FIG. 2 is a diagram illustrating equivalent circuits in the liquid crystal panel 100.

As illustrated in FIG. 2, the liquid crystal panel 100 includes pixels 110. The pixel 110 includes a liquid crystal element 120 in which a liquid crystal 105 is interposed between the pixel electrode 118 and a common electrode 108, in the intersection of the scan lines 112 and the data lines 114. In the liquid crystal element 120, a molecule alignment state of the liquid crystal 105 is changed according to the electric field that is generated by the pixel electrode 118 and the common electrode 108. For this reason, if a transmission type, the liquid crystal element 120 has a transmission rate according to an application voltage and a retention voltage. The transmission rate of the liquid crystal panel 100 is changed for each liquid crystal element 120 (each pixel 110).

Auxiliary capacitors (storage capacitors) 125 that are connected in parallel to the liquid crystal elements 120 are provided in each of the pixels 110, as actually illustrated in FIG. 2, but not illustrated in FIG. 1. The auxiliary capacitor 125 has one terminal connected to the pixel electrode 118 and the other terminal connected in common to a capacitor line 115. The capacitor line 115 is maintained at a temporally constant voltage.

Here, if the scan lines 112 goes to an H level, the TFT 116, the gate electrode of which is connected to the scan line 112, is turned on, and the pixel electrode 118 is connected to the data line 114. For this reason, if, when the scan line 112 is at an H level, a data signal of a voltage according to the data signal Vx is supplied to the data lines 114, the data signal is applied to the pixel electrode 118 via the TFT 116 that is turned on. If the scan line 112 is at an L level, the TFT 116 is turned off, but a voltage that is applied to the pixel electrode 118 is maintained by the capacitance of the liquid crystal element 120, and is retained in the auxiliary capacitor 125 that is connected in parallel to the liquid crystal element 120.

In the present embodiment, the liquid crystal 105 is configured by a vertical alignment (VA) method, each of the liquid crystal elements 120 enters a normally black mode that is a black state when a voltage is not applied.

Description will be made by returning to FIG. 1.

A scan line drive circuit 130 sequentially supplies the scan lines 112 of the first row, the second row, the third row, . . . , and the mth row with scan signals Y1, Y2, Y3, . . . , Ym, in response to a control signal Yctr output from the scan control circuit 20. Specifically, the scan line drive circuit 130 selects the scan line 112 one by one in the sequence of the first row, the second row, the third row, . . . , and the mth row, applies the scan signal to the selected scan line 112 as a selection voltage V_{H} (H level), and applies the scan signal to the other scan lines 112 as a non-selection voltage V_{L} (L level).

Here, one frame is a period required for displaying an amount of one frame of an image by driving the liquid crystal panel 100. If the frequency of the vertical scan signal that is included in the synchronization signal Sync is 120 Hz, One frame is approximately 8.3 milliseconds that is an inverse number thereof.

The data line drive circuit 140 samples the data signal Vx that is supplied from the video processing circuit 30 as the data signals X1, X2, X3, X4, X5, X6, . . . , Xn−1, and Xn, and applies the sampled signals to the data lines 114 of the first column, the second column, the third column, the fourth column, the fifth column, the sixth column, . . . , the (n−1)th column, and the nth column, in response to a control signal Xctr output from the scan control circuit 20.

The scan line drive circuit 130 and the data line drive circuit 140 configure drive circuits that drive the liquid crystal panel 100 in the sequence of lines.

In the present embodiment, with regard to voltages, a ground voltage that is not illustrated is set as a reference of a voltage that is zero, except for an application voltage of the liquid crystal element 120, particularly unless otherwise described. The application voltage of the liquid crystal element 120 is a voltage difference between a voltage LCcom of the common electrode 108 and the pixel electrode 118, and is distinguished from other voltages.

The glasses control unit 40 transmits a control signal CS to 3D glasses 50 through, for example, ultraviolet communication. The control signal CS is a control signal which indicates whether a display period is a display period of a right eye image or a display period of a left eye image, when a 3D video is displayed. The 3D glasses 50 include a right eye lens section that is a liquid crystal shutter 52R, and a left eye lens section that is a liquid crystal shutter 52L. The liquid crystal shutters 52R and 52L are respectively controlled in a transmission state or a non-transmission state, according to the control signal CS or the like that is received by a receiving unit 51. In detail, when a 3D video is displayed, during a right eye open period, the liquid crystal shutter 52R is in a transmission state and the liquid crystal shutter 52L is in a non-transmission state, and during a left eye open period, the liquid crystal shutter 52R is in a non-transmission state and the liquid crystal shutter 52L is in a transmission state. During the other periods, the liquid crystal shutters 52R and 52L are together in a non-transmission state.

FIG. 3 is a diagram illustrating a display operation of the control circuit 10.

The frequency of a vertical scan signal of the liquid crystal panel 100 that is controlled by the synchronization signal Sync is 240 Hz in the present embodiment. As illustrated in FIG. 3, the control circuit 10 divides one frame into two fields of a first field and a second field, and scans (selects) the scan lines of the first to mth rows one by one in each of the divided fields. That is, based on the input video signal Vid-in that is supplied in supplying speed of 120 Hz from a higher level device, the control circuit 10 drives the liquid crystal panel 100 in driving speed of 240 Hz. One field period corresponds to (½) frame period, and here, is approximately 4.2 milliseconds.

A writing polarity of the data signal Vx will be described. The control circuit 10 designates a positive writing (+) in the first field, and designates a negative writing (−) in the second field. That is, control circuit 10 inverts the writing polarity in each field, and writes the data signal Vx to the pixel 110. The control signal 10 writes the data signal Vx to the pixel 110, in such a manner that a left eye image L and a right eye image R are alternately displayed in each frame.

The control of the 3D glasses 50 will be described. The control circuit 10 sets the liquid crystal shutters 52R and 52L of the 3D glasses 50 to a non-transmission state (“OFF” of FIG. 3) in the first field. In the second field of the frame in which the left eye image L is displayed, the control circuit 10 sets the liquid crystal shutter 52L of the 3D glasses 50 to a transmission state (“left ON” of FIG. 3) and sets the liquid crystal shutter 52R to a non-transmission state. In the second field of the frame in which the right eye image R is displayed, the control circuit 10 sets the liquid crystal shutter 52L of the 3D glasses 50 to a non-transmission state and sets the liquid crystal shutter 52R to a transmission state (“right ON” of FIG. 3).

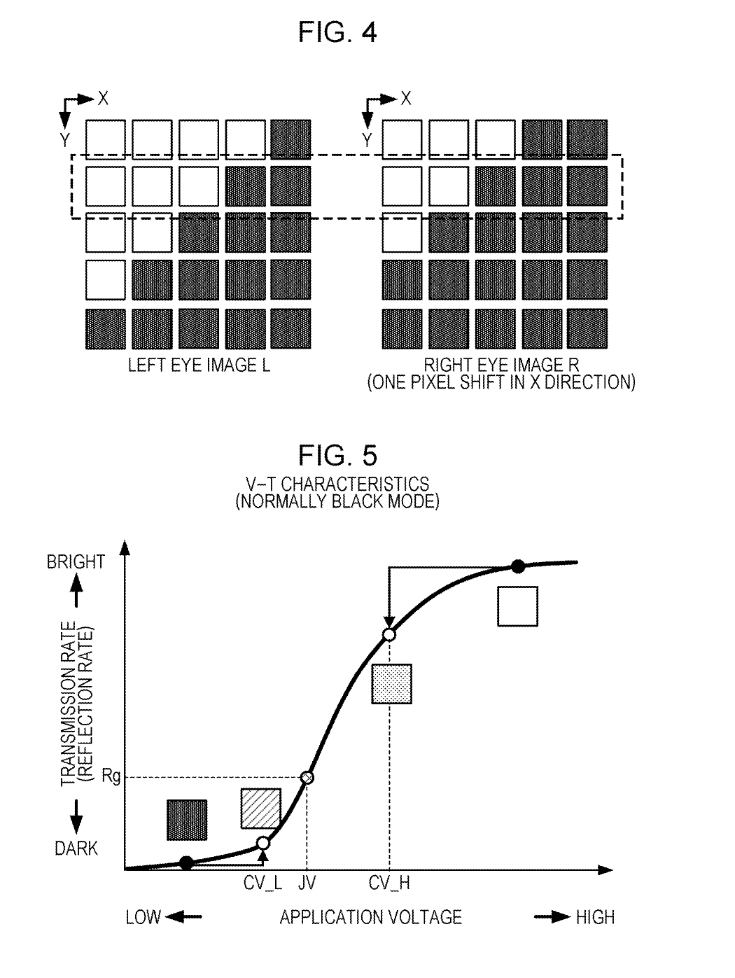

FIG. 4 is diagram illustrating a display example of both a left eye image L and a right eye image R. In FIG. 4, one square corresponds to one pixel, and an area configured by 5×5 pixels in the X direction and the Y direction is illustrated. The right eye image R illustrated in FIG. 4 is a video in which the left eye image L is moved in the X direction, and herein, is a video in which the left eye image L is moved by one pixel in the X direction. Hereinafter, a pixel that displays a relatively bright gradation is referred to as a “bright pixel”, and a pixel that displays a relatively dark gradation is referred to as a “dark pixel”. Specific conditions of the bright pixel and the dark pixel will be described using FIG. 5.

FIG. 5 is a graph illustrating a relationship (V-T characteristics) between an application voltage that is designated in the pixel 110 and a transmission rate of the liquid crystal element 120 that is included in the pixel 110. In the graph illustrated in FIG. 5, a horizontal axis denotes an application voltage that is designated to the pixel 110, and a vertical axis denotes a transmission rate (specifically, relative transmission rate) of the liquid crystal element 120.

As illustrated in FIG. 5, in the normally black mode, the higher the application voltage to the pixel 110 is, the greater the transmission rate (or reflection rate) of the pixel 110 is. In the present embodiment, the dark pixel is the pixel 110 in which the application voltage designated by the input video signal Vid-in is equal to or lower than a threshold voltage JV, and the bright pixel is the pixel 110 in which the designated application voltage is higher than the threshold voltage JV. The threshold voltage JV corresponds to a predetermined gradation (gradation level) in which the transmission rate (or reflection rate) of the liquid crystal element 120 is displayed at the time of “Rg” illustrated in FIG. 5. Thus, the dark pixel is a pixel (first pixel) that displays a gradation equal to or lower than a predetermined gradation, and the bright pixel is a pixel (second pixel) that displays a gradation higher than the predetermined gradation.

The threshold voltage JV is set, for example experimentally or by calculation, based on easy perception of reverse tilt generation region. There is a voltage corresponding to an inflection point of V-T characteristic as a setting example of the threshold voltage JV, but the threshold voltage JV is not limited to this.

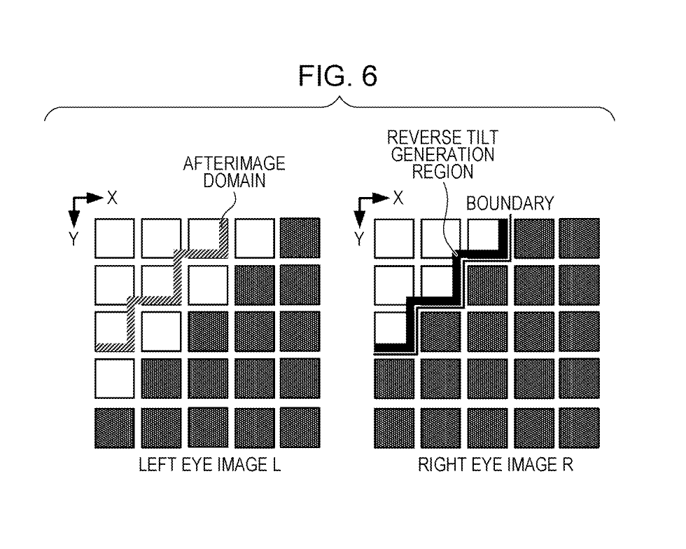

In a case in which a voltage designated by the input video signal Vid-in is applied to the pixel 110 in the liquid crystal panel 100 as it is, a reverse tilt domain may be generated according to a difference of an application voltage between two pixels 110 adjacent to each other. In the present embodiment, it is assumed that there is a case in which, when viewing from the dark pixel, a generation region (hereinafter, referred to as “reverse tilt generation region”) of the reverse tilt domain appears along a top side or a left side. In this case, when the right eye image R illustrated in FIG. 4 is displayed, the reverse tilt generation region appears in a position illustrated in FIG. 6. Then, in a case in which the left eye image L is displayed in the next frame of the right eye image R, an afterimage domain that causes the reverse tilt domain of the right eye image R can be recognized by a user in a position illustrated in FIG. 6.

Thus, the video processing circuit 30 performs video processing for suppressing the generation of afterimage domain, based on the input video signal Vid-in.

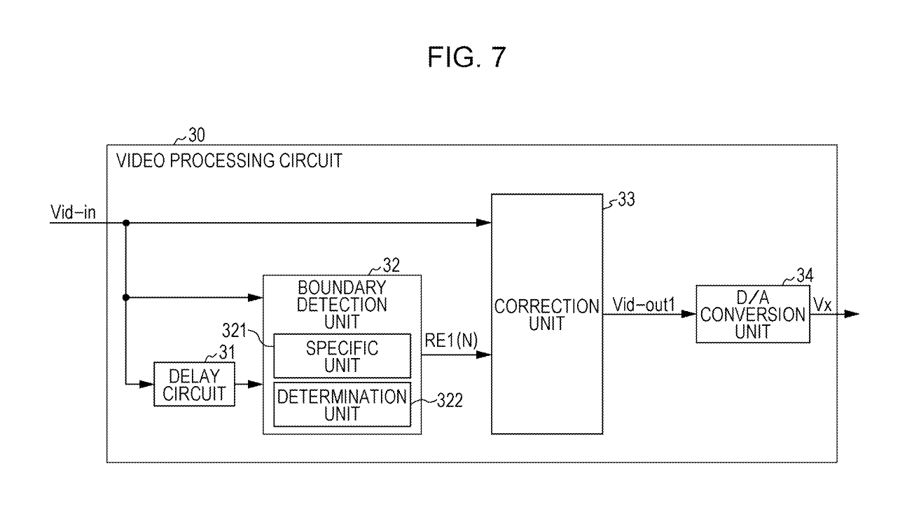

FIG. 7 is a block diagram illustrating a configuration of the video processing circuit 30.

As illustrated in FIG. 7, the video processing circuit 30 includes a delay circuit 31, a boundary detection unit 32, a correction unit 33, and a D/A conversion unit 34.

The delay circuit 31 includes a first in first out (FIFO) memory, a multi-stage latch circuit, and the like, stores the supplied input video signals Vid-in, reads the signal after one frame period passes, and outputs the signal to the boundary detection unit 32. Storing or reading of the delay circuit 31 is controlled by the scan control circuit 20.

The boundary detection unit 32 detects the boundary between a dark pixel and a bright pixel in the current frame, based on the input video signal Vid-in in the current frame and a frame (hereinafter, referred to as “previous frame”) before one frame of the current frame. The previous frame is an example of a frame that is adjacent to the current frame on the time axis. The input video signal Vid-in in the previous frame is supplied to the boundary detection unit 32 by the delay circuit 31. The function of the boundary detection unit 32 is roughly divided into a specific unit 321 and a determination unit 322.

The specific unit 321 specifies a dark pixel that is adjacent to a bright pixel, based on the input video signal Vid-in in the current frame. Here, the specific unit 321 specifies the dark pixel which is adjacent to a bright pixel in a direction (left direction) opposite to the X direction or a direction (top direction) opposite to the Y direction, among the dark pixels.

The determination unit 322 determines whether or not a bright pixel exists in the previous frame in a position of the dark pixel that is specified by the specific unit 321, based on the input video signal Vid-in in the previous frame. As described above, the control circuit 10 divides one frame into two fields, and drives the liquid crystal panel 100. For this reason, the determination unit 322 determines whether or not a bright pixel exists in a position of the dark pixel in one field of the current frame, in the last field of the previous frame. The last field of the previous frame is the closest field from each field of the current frame on the time axis, among the previous frame.

In a case in which the determination unit 322 determines that a bright pixel exists in the previous frame, the boundary detection unit 32 outputs positional information RE1 (N) indicating a position of a boundary between the dark pixel that is specified by the specific unit 321 and the bright pixel adjacent to the dark pixel to the correction unit 33.

In a case in which a 3D video is displayed, the left eye image L and the right eye image R which are the same as each other may be continuously and alternately displayed for a certain period. For this reason, the boundary detection unit 32 determines whether or not a bright pixel in the previous frame exists in a position of the dark pixel in the current frame, thereby being able to detect (estimate) a location in which afterimage domain in a frame (hereinafter, referred to as “subsequent frame”) after one frame of the current frame is generated.

The correction unit 33 corrects the input video signal Vid-in in the current frame, based on the positional information RE1 (N) that is supplied from the boundary detection unit 32. Specifically, the correction unit 33 sets at least one of the dark pixel and the bright pixel as a correction target, so as to reduce the difference of an application voltage between the dark pixel and the bright pixel which are in contact with the boundary of a position that the positional information RE1 (N) indicates, and corrects the input video signal Vid-in in the current frame. The correction unit 33 outputs the corrected video signal to the D/A conversion unit 34 as an output video signal Vid-out1. On the other hand, in a case in which the input video signal Vid-in is not corrected based on the positional information RE1 (N), the correction unit 33 outputs the input video signal Vid-in as the output video signal Vid-out1 as it is.

The D/A conversion unit 34 functions as an output unit that converts the output video signal Vid-out1 which is a digital data input from the correction unit 33 into an analog data signal Vx and outputs the converted signal. That is, the D/A conversion unit 34 outputs the data signal Vx for driving the liquid crystal panel 100 to the data line drive circuit 140, based on the output video signal Vid-out1.

In order to prevent DC components from being applied to the liquid crystal 105, a voltage of the data signal Vx is alternately switched to a positive voltage on a high potential side and a negative voltage on a low potential side with respect to the voltage Vcnt that is a video amplitude center, for each field herein.

The voltage LCcom that is applied to the common electrode 108 may be considered to be approximately the same voltage as the voltage Vcnt, but may be adjusted so as to be a lower potential than the voltage Vcnt, by taking into account off-leakage of the n channel type TFT 116.

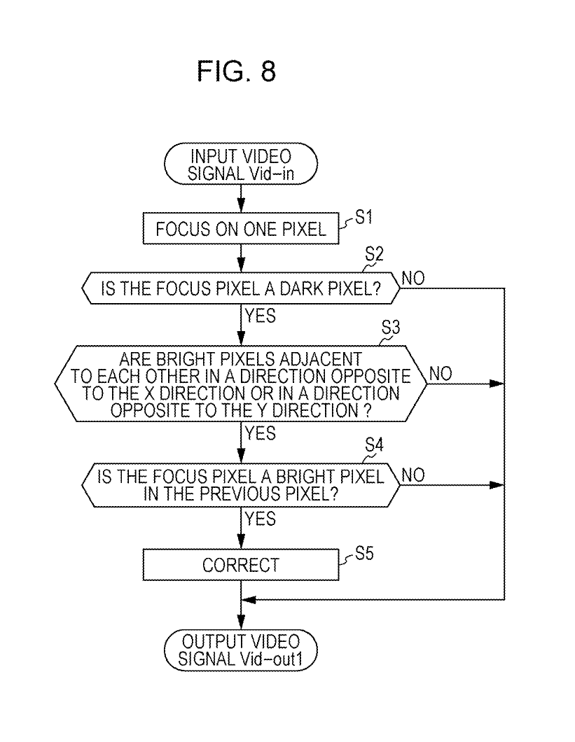

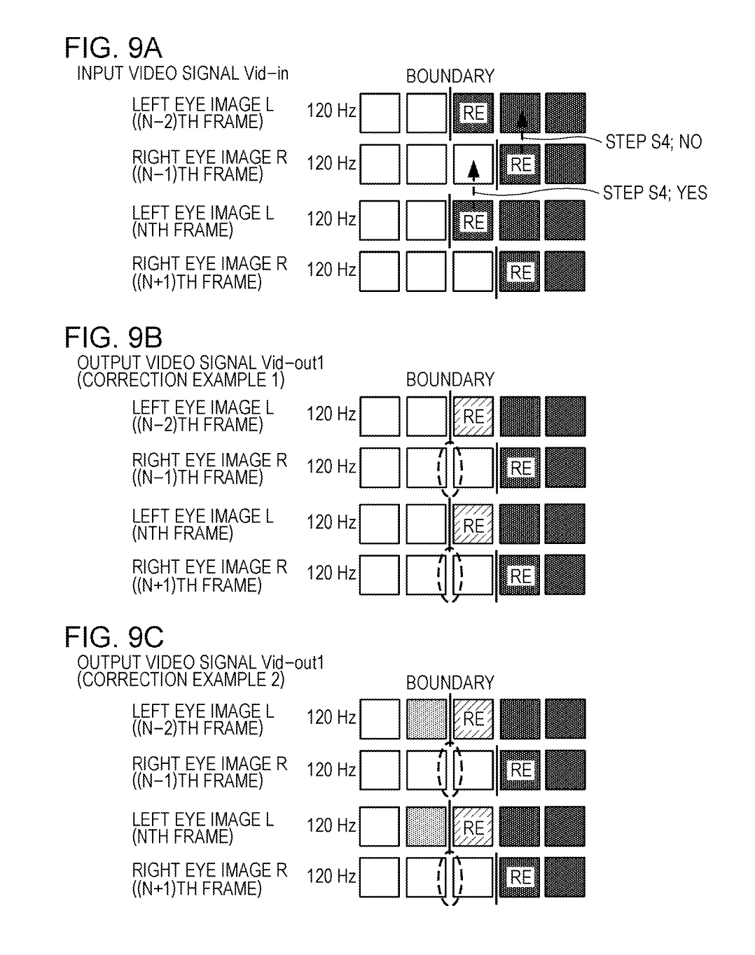

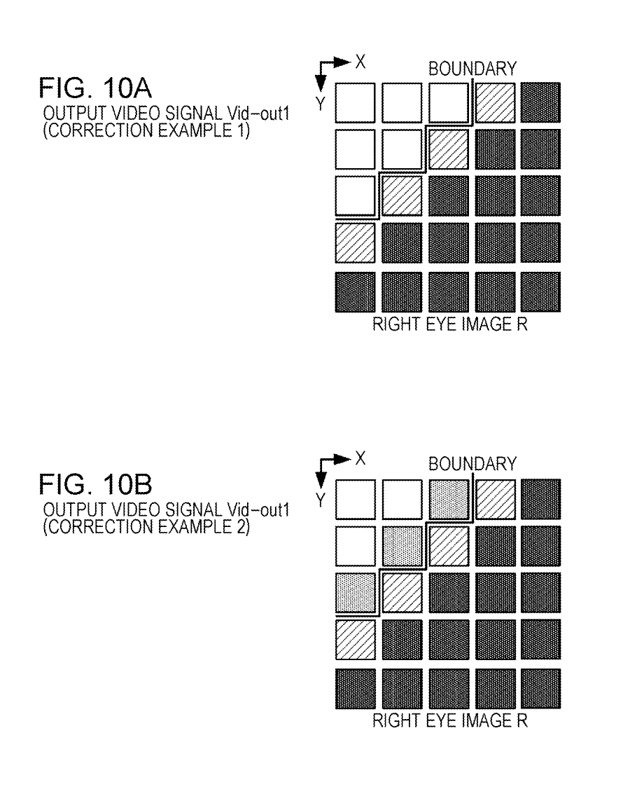

FIG. 8 is a flow chart illustrating video processing that is performed by the image processing circuit 30. FIGS. 9A to 9C and FIGS. 10A and 10B are diagrams illustrating a specific example of the video processing that is performed by the image processing circuit 30. Specific examples of the video processing with regard to the pixels of an area that is surrounded by the dashed line in FIG. 4 are illustrated in FIGS. 9A to 9C.

First, the video processing circuit 30 focuses on one pixel based on the input video signal Vid-in, and sets the pixel as a focus pixel (step S1). Subsequently, the video processing circuit 30 determines whether or not the focus pixel is a dark pixel (step S2).

In a case in which it is determined that the focus pixel is not a dark pixel, that is, is a bright pixel (step S2; NO), the video processing circuit 30 sets the input video signal Vid-in as an output video signal Vid-out1, converts the signal into the data signal Vx, and outputs the data signal Vx.

In a case in which it is determined that the result is “YES” in the processing of step S2, the video processing circuit 30 determines whether or not the bright pixel is adjacent to the dark pixel in a direction opposite to the X direction (left direction) or a direction opposite to the Y direction (top direction) when viewing from the dark pixel that is the focus pixel (step S3).

Here, as illustrated in FIG. 9A, a case in which the input video signals Vid-in of each frame from (N−2) frame to (N+1) frame are sequentially supplied to the video processing circuit 30 is considered. In this case, when the dark pixel that is denoted by “RE” is set as the focus pixel, the video processing circuit 30 determines that the result of step S3 is “YES”. In a case in which it is determined that the result of step S3 is “NO”, the video processing circuit 30 sets the input video signal Vid-in as the output video signal Vid-out1, converts the signal into the data signal Vx, and outputs the data signal Vx.

If it is determined that the result of step S3 is “YES” and a dark pixel adjacent to a bright pixel is specified, the video processing circuit 30 determines whether or not the bright pixel exists in the previous frame in a position in which the dark pixel exists (step S4). For example, in a case in which the Nth frame is set as the current frame and the dark pixel denoted by “RE” is specified, a bright pixel exists in the position of the dark pixel, in the (N−1) frame that is the previous frame. In which case, the video processing circuit 30 determines that the result of step S4 is “YES”. In a case in which it is determined that the result of step S4 is “YES”, the video processing circuit 30 determines the pixel of a correction target, based on a boundary between the specified dark pixel and a bright pixel adjacent to the dark pixel, and corrects the input video signal Vid-in in the current frame (step S5). Then, the video processing circuit 30 sets the corrected video signal as the output video signal Vid-out1, converts the signal into the data signal Vx, and outputs the data signal Vx.

In step S5, in a case in which a dark pixel is set as a correction target, the video processing circuit 30 corrects the input video signal Vid-in of a dark pixel to a video signal that designates an application voltage CV_L, as illustrated in correction example 1 of FIG. 9B. As illustrated in FIG. 5, the application voltage CV_L is a voltage higher than the application voltage before the dark pixel is corrected. The application voltage CV_L may be a fixed voltage, and may be set in accordance with an application voltage that is designated to a bright pixel adjacent to the specified dark pixel. In a case of the latter, the video processing circuit 30 may increase the application voltage CV_L, as long as the application voltage designated to a bright pixel increases.

The generation of a reverse tilt domain is suppressed by the correction, in the vicinity of a boundary between a dark pixel and a bright pixel in the left eye image L. As a result, it is difficult for a display abnormality due to an afterimage domain to be viewed to a user, in the right eye image R of the subsequent frame (refer to an elliptical section of dashed line of FIG. 9B).

In step S5, the video processing circuit 30 may set a dark pixel and a bright pixel as a correction target. In this case, the video processing circuit 30 corrects the input video signal Vid-in of a dark pixel to a video signal that designates the application voltage CV_L and corrects the input video signal Vid-in of a bright pixel to a video signal that designates an application voltage CV_H, as illustrated in correction example 2 of FIG. 9C. The application voltage CV_H may be a fixed voltage, and may be set in accordance with an application voltage that is designated to the specified dark pixel. In a case of the latter, the video processing circuit 30 may decrease the application voltage CV_H, as long as the application voltage designated to a dark pixel decreases.

The generation of a reverse tilt domain is suppressed by the correction, in the vicinity of a boundary between a dark pixel and a bright pixel in the left eye image L, and it is difficult for a display abnormality due to an afterimage domain to be viewed to a user, in the right eye image R of the subsequent frame (refer to an elliptical section of dashed line of FIG. 9C). In addition, in a case of correction example 2, the number of pixels of a correction target is increased, compared to a case of correction example 1, but it is also possible to decrease a correction amount per one pixel.

In a case in which the video processing described above is performed in the input video signal Vid-in illustrated in FIG. 4, the output video signal Vid-out1 is as illustrated in FIGS. 10A and 10B. FIG. 10A corresponds to correction example 1, and FIG. 10B corresponds to correction example 2. As illustrated in FIGS. 10A and 10B, a pixel that exists in a location in which the afterimage domain illustrated in FIG. 6 is generated is a correction target, and thus, it is difficult for a display abnormality caused by the afterimage domain to be viewed to a user.

In step S5, the video processing circuit 30 may not set a dark pixel as a correction target, and may be set a bright pixel as a correction target. In addition, the video processing circuit 30 may set the number of correction processing of a bright pixel or/and a dark pixel to “2” or more. The number of correction processing is counted from the pixels in contact with a boundary between a dark pixel and a bright pixel, and refers to the number of pixels of a correction target which is consecutive in a direction opposite to the boundary. For example, in a case in which the number of correction processing is “3”, the pixels in contact with the boundary are counted, and three pixels that are consecutive in a direction opposite to the boundary is set as a correction target.

In a case in which, in the processing of step S4, it is determined that the focus pixel is not a bright pixel, that is, is a dark pixel in the previous frame (step S4; NO), and the video processing circuit 30 sets the input video signal Vid-in as the output video signal Vid-out1, converts the signal into the data signal Vx, and outputs the data signal Vx.

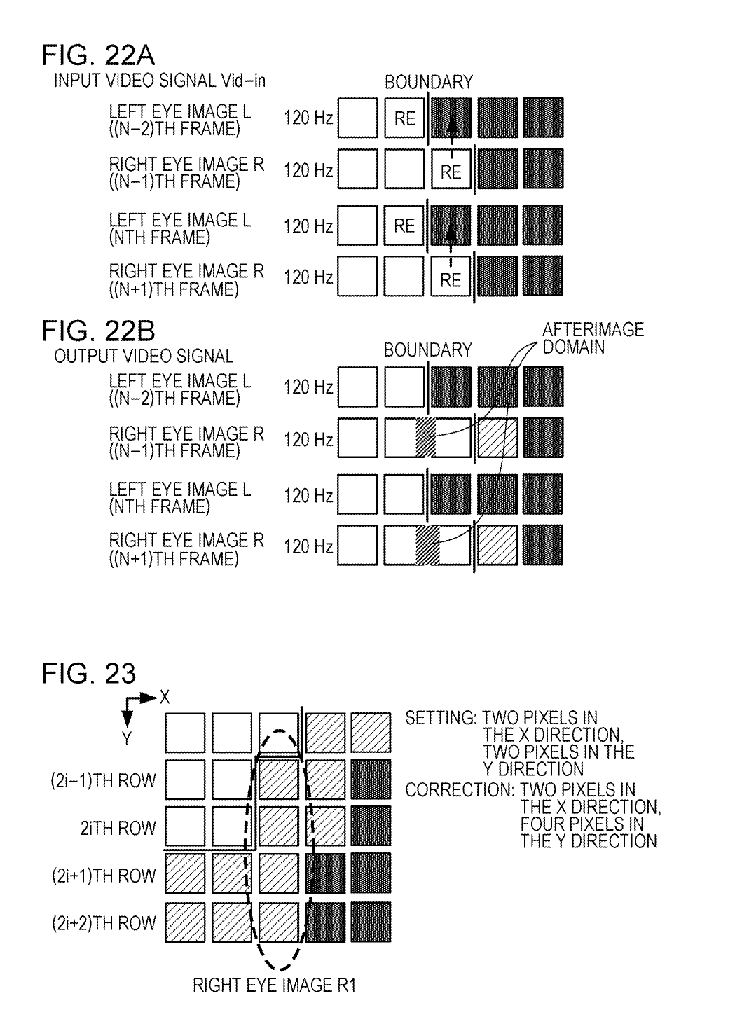

FIGS. 22A and 22B are diagrams illustrating video processing in a case in which the processing of step S2 is replaced with a step that determines whether or not the focus pixel is a bright pixel. In this case, when the bright pixel denoted by “RE” in FIG. 22A is a focus pixel, a pixel of a correction target is determined. At this time, as illustrated in FIG. 22B, a pixel in contact with a location in which an afterimage domain is generated is not a correction target, and thereby the display abnormality due to the afterimage domain is easily viewed to a user. Thus, the video processing circuit 30 determines whether or not the focus pixel is a dark pixel, in step S2.

As described above, according to the video processing that is performed by the video processing circuit 30, it is possible to suppress the generation of the display abnormality caused by the afterimage domain. In addition, the effect of suppressing the afterimage domain is also obtained in the same manner as in a case of a video in which a display unit with a low black gradation is disposed with respect to a background unit with a high gradation.

### Second Embodiment

Next, a second embodiment of the invention will be described.

The control circuit 10 performs a display operation that will be described below in the electro-optical device 1 according to the second embodiment.

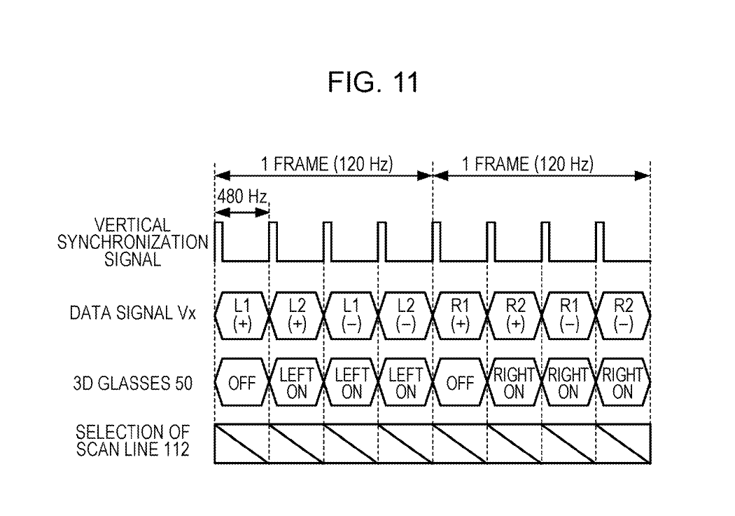

FIG. 11 is a diagram illustrating the display operation of the control circuit 10 according to the present embodiment.

In the present embodiment, the frequency of the vertical scan signal of the liquid crystal panel 100 that is controlled by the synchronization signal Sync is 480 Hz. As illustrated in FIG. 11, the control circuit 10 divides one frame into four fields of a first field to a fourth field, and scans the first to mth scan lines in each of the divided fields.

The writing polarity of the data signal Vx will be described. The control circuit 10 inverts the writing polarity in the respective two fields, and performs writing of the data signal Vx to the pixels 110. In addition, the control circuit 10 performs the writing of the data signal Vx to the pixels 110 in such a manner that a left eye image and a right eye image are alternately displayed in each frame. However, in the frame in which the left eye image is displayed, the control circuit 10 displays a left eye image L1 in the first field and the third field, and displays a left eye image L2 in the second field and the fourth field. In addition, in the frame in which the right eye image is displayed, the control circuit 10 displays a right eye image R1 in the first field and the third field, and displays a right eye image R2 in the second field and the fourth field.

The control of the 3D glasses 50 will be described. The control circuit 10 sets the liquid crystal shutters 52R and 52L of the 3D glasses 50 as a non-transmission state in the first field of each frame, sets the liquid crystal shutter 52L of the 3D glasses 50 as a transmission state and the liquid crystal shutter 52R as a non-transmission state in the second to fourth fields of the frame that displays a left eye image, and sets the liquid crystal shutter 52L of the 3D glasses 50 as a non-transmission state and the liquid crystal shutter 52R as a transmission state in the second to fourth fields of the frame that displays a right eye image. As a result, a period in which the liquid crystal shutters 52L and 52R are in a transmission state is lengthened, and the brightness of the 3D video that is viewed to a user is increased, further than in a case of the first embodiment described above.

In addition, as illustrated in FIG. 11, in the present embodiment, the period of one field is half (½) of that of the first embodiment described above. For this reason, the control circuit 10 selects the plurality of san lines 112 on a per K piece (K is an integer equal to or greater than 2) basis, performs “a plurality of simultaneous writes” in which the data signal Vx is written to the pixels 110 corresponding to each of the scan lines 112. In the present embodiment, K is set to 2, and the control circuit 10 simultaneously selects two scan lines 112 that are adjacent to each other in the Y direction.

When a plurality of simultaneous writes is performed, the input video signal Vid-in which is obtained by thinning out a video signal of one frame by half in the Y direction is supplied in each frame from a higher level device to the electro-optical device 1. Here, the input video signal Vid-in that designates an application voltage with regard to the pixel 110 of the ith rows (i=1, 3, 5, . . . ) that are odd rows is supplied.

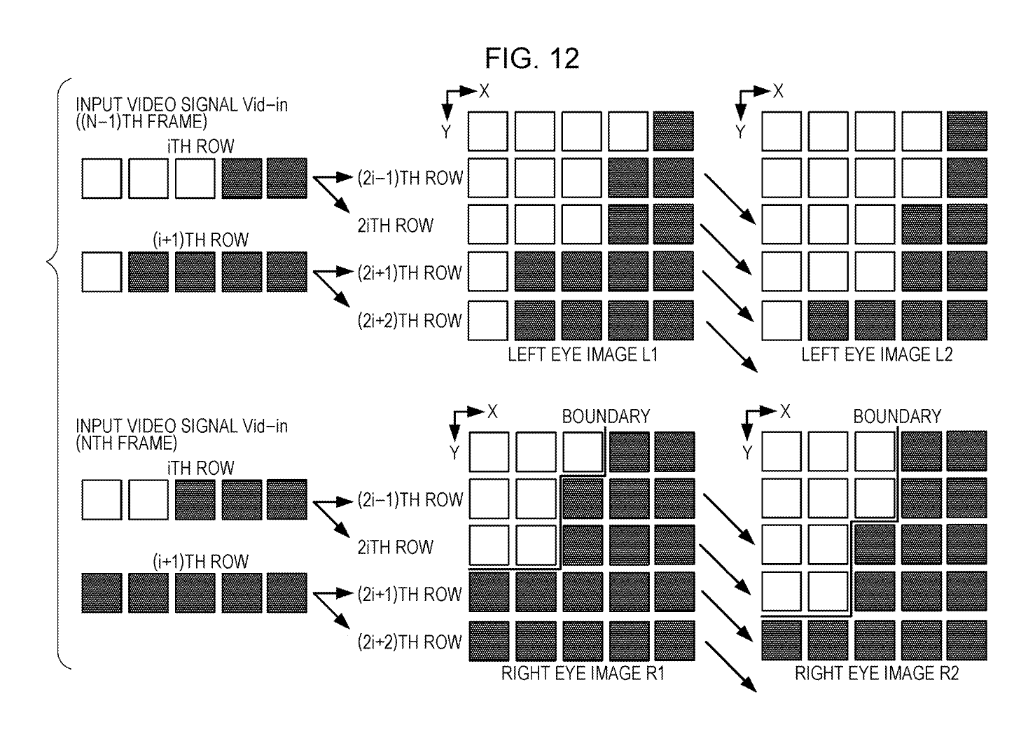

Then, as illustrated in FIG. 12, in a case in which the left eye image L1 is displayed in an (N−1)th frame, and a case in which the right eye image R1 is displayed in an Nth frame, the control circuit 10 writes the data signal Vx to the pixels 110 corresponding to the scan lines 112 of the (2i−1)th row and the 2ith row, based on the input video signal Vid-in of the pixel corresponding to the scan line 112 of the ith row. In the same manner, the control circuit 10 writes the data signal Vx to the pixels 110 corresponding to the scan lines 112 of the (2i+1)th row and the (2i+2)th row, based on the input video signal Vid-in of the pixel corresponding to the scan line 112 of the (i+1)th row. In addition, in an (N−1)th frame, in a case in which the left eye image L2 is displayed, the control circuit 10 writes the data signal Vx that is obtained by shifting the left eye image L1 by one row (by one pixel) in the Y direction. In the same manner, in an Nth frame, in a case in which the right eye image R2 is displayed, the control circuit 10 writes the data signal Vx that is obtained by shifting the right eye image R1 by one row (by one pixel) in the Y direction.

A resolution ha in the Y direction is lowered by the plurality of simultaneous writes, and the brightness of a 3D video that is viewed to a user is increased by a fast drive of the liquid crystal panel 100.

In a case in which the number P (P is a natural number) of correction processing in the X direction and the number Q (Q is a natural number) of correction processing in the Y direction are simultaneously set under the display operation described above, problems of video processing which will be described below may occur. Here, a case in which the number P of correction processing in the X direction and the number Q of correction processing in the Y direction are both set to “2” is considered with regard to a dark pixel.

In this case, as illustrated in FIG. 23, with regard to the X direction, two dark pixels that are consecutive in the X direction from a boundary between a dark pixel and a bright pixel become a correction target. However, with regard to the Y direction, four dark pixels that are consecutive in the Y direction from a boundary between a dark pixel and a bright pixel become a correction target. The reason is that the plurality of simultaneous writes is performed based on the two dark pixels which are consecutive in the Y direction and are correction targets. According to this, the number of pixels that are correction targets with regard to the Y direction is unintentionally increased, and the change of display contents due to the correction is easily viewed to a user. That is, in a case in which the plurality of simultaneous writes is performed, a discrepancy between setting of the numbers P and Q of correction processing and the number of pixels of actual correction target may occur.

Thus, in a case in which the plurality of scan lines 112 are selected on a per K piece basis, the video processing circuit 30 of the present embodiment sets the number Q of correction targets in the Y direction to a number smaller than the number P of correction targets in the X direction. Specifically, the video processing circuit 30 sets the number Q of correction processing to (1/K) of the number P of correction processing. For example, the video processing circuit 30 sets the number P of correction processing to “2”, and sets the number Q of correction processing to “1”.

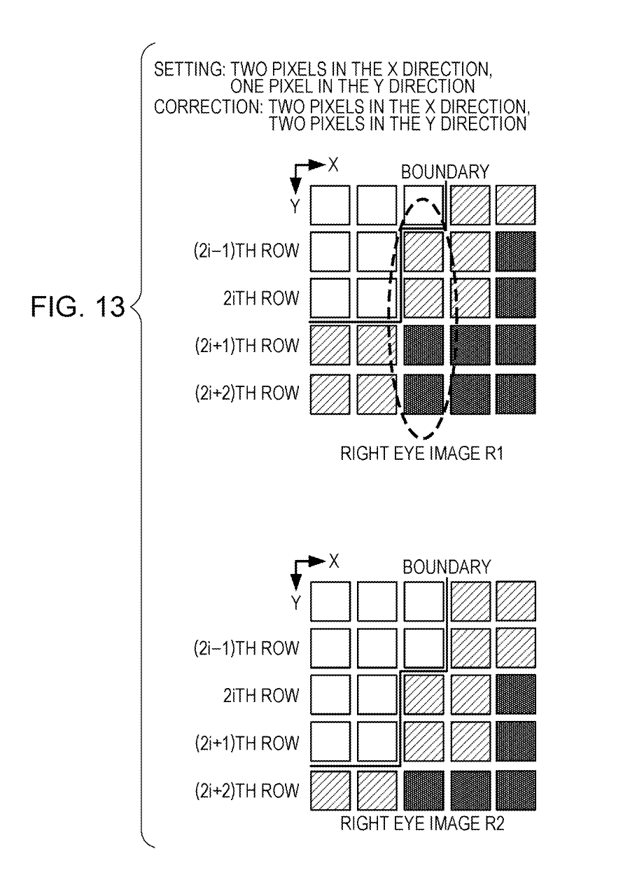

According to this, in a case in which the input video signal Vid-in indicating the right eye image R1 and the right eye image R2 which are illustrated in FIG. 12 is corrected, the right eye image R1 and the right eye image R2 which are illustrated in FIG. 13 are displayed. As illustrated in FIG. 13, also in a case in which the plurality of simultaneous writes are performed by the video processing of the present embodiment, it is possible to suppress that the change of display contents due to correction is viewed to a user.

### Third Embodiment

Next, a third embodiment according to the invention will be described.

The electro-optical device 1 according to the third embodiment has a function of displaying not only a 3D video but also a 2D video. Furthermore, a video processing circuit according to the present embodiment performs differently from each other video processing for suppressing the generation of a reverse tilt domain, in a case in which a 3D video is displayed and a case in which a 2D video is displayed. Specifically, the video processing circuit performs video processing for suppressing the afterimage domain described above, in a case in which a 3D video is displayed, and performs video processing for suppressing a reverse tilt domain (hereinafter, referred to as “moving image domain”) that is generated by moving image display, in a case in which a 2D video is displayed.

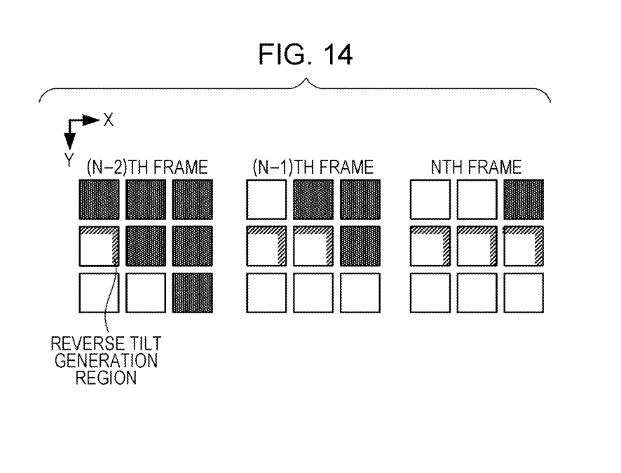

FIG. 14 is a diagram illustrating a cause of the generation of a moving image domain. As illustrated in FIG. 14, a case is considered in which a bright pixel (third pixel) moves by one pixel per frame in the X direction in the sequence of an (N−2)th frame, an (N−1)th frame, and an Nth frame, by using a dark pixel (fourth pixel) as a background. It is assumed that the conditions of a dark pixel and a bright pixel at the time of displaying a 2D video are different from the conditions of a dark pixel and a bright pixel at the time of displaying a 3D video described above. Specifically, a dark pixel at the time of displaying a 2D video is the pixel 110 to which an application voltage equal to or lower than a predetermined voltage is applied, and a bright pixel at the time of displaying a 2D video is the pixel 110 to which an application voltage higher than the predetermined voltage is applied. The predetermined voltage may be a voltage that is the same as a threshold voltage JV and may be a voltage different from the threshold voltage JV.

As described in FIG. 14, a pixel that has to be changed from a dark pixel to a bright pixel according to the motion of a video does not become an original gradation due to generation of the reverse tilt domain, and thereby a moving image domain is generated. A reverse tilt generation region of a plurality of bright pixels is connected, and thereby, the moving image domain is manifested as a type of a tailing phenomenon. Thus, in order to suppress display abnormality that is caused by the moving image domain, the pixel of a correction target may be determined by focusing on a pixel that is changed from a dark pixel to a bright pixel over the current frame from the previous frame.

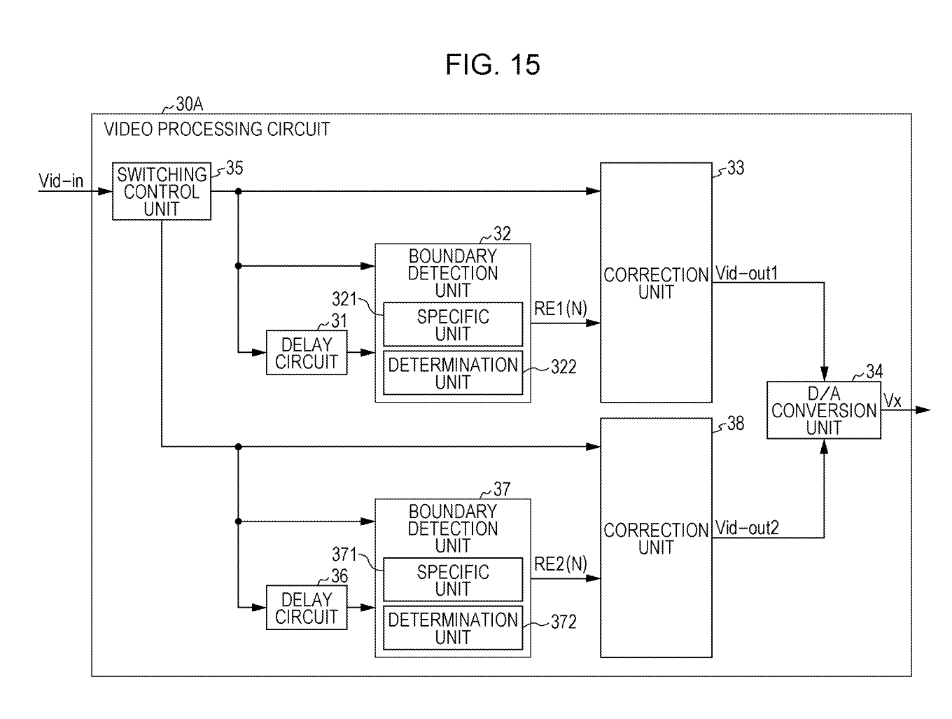

FIG. 15 is a block diagram illustrating a configuration of a video processing circuit 30A according to the present embodiment.

As illustrated in FIG. 15, the video processing circuit 30A includes a switching control unit 35, a delay circuit 36, a boundary detection unit 37, and a correction unit 38, in addition to the delay circuit 31, the boundary detection unit 32, the correction unit 33, and the D/A conversion unit 34 which are described in the first embodiment described above.

The switching control unit 35 controls switching of an output destination of the input video signal Vid-in that is supplied. The switching control unit 35 determines whether the input video signal Vid-in indicates a 3D video or a 2D video, based on a signal that is output from a circuit block (not illustrated) which is provided in a higher level device or the video processing circuit 30A and determines whether a display video is a 3D video or a 2D video. The switching control unit 35 outputs the input video signal Vid-in to the delay circuit 31, the boundary detection unit 32, and the correction unit 33, in a case in which it is determined that a display video is a 3D video. The switching control unit 35 outputs the input video signal Vid-in to the delay circuit 36, the boundary detection unit 37, and the correction unit 38, in a case in which it is determined that a display video is a 2D video.

The delay circuit 36 has the same configuration as the delay circuit 31, stores the input video signal Vid-in that is supplied, reads the input video signal after one frame period passes, and outputs the input video signal to the boundary detection unit 37. Storing in and reading from the delay circuit 36 are controlled by the scan control circuit 20.

The boundary detection unit 37 detects a boundary between a dark pixel and a bright pixel in the current frame, based on the input video signal Vid-in in the current frame and the previous frame. The input video signal Vid-in in the previous frame is supplied to the boundary detection unit 37 by the delay circuit 36. The function of the boundary detection unit 37 is roughly divided into a specific unit 371 and a determination unit 372.

The specific unit 371 specifies a bright pixel that is adjacent to a dark pixel, based on the input video signal Vid-in in the current frame. Here, the specific unit 371 specifies one bright pixel that is adjacent to a dark pixel in the X direction (right direction) or the Y direction (bottom direction), among the bright pixels.

The determination unit 372 determines whether or not a dark pixel exists in the current frame in a position of the bright pixel that is specified by the specific unit 371, based on the input video signal Vid-in in the current frame.

In a case in which the determination unit 372 determines that a dark pixel exists in the previous frame, the boundary detection unit 37 outputs positional information RE2 (N) indicating a position of a boundary between the bright pixel that is specified by the specific unit 371 and the dark pixel adjacent to the bright pixel to the correction unit 38.

The correction unit 38 corrects the input video signal Vid-in in the current frame, based on the positional information RE2 (N) that is supplied from the boundary detection unit 37. Specifically, the correction unit 38 sets at least one of the dark pixel and the bright pixel as a correction target, so as to reduce the difference of an application voltage between the dark pixel and the bright pixel which are in contact with the boundary of a position that the positional information RE2 (N) indicates, and corrects the input video signal Vid-in in the current frame. The correction unit 38 outputs the corrected video signal to the D/A conversion unit 34 as an output video signal Vid-out2. In a case in which the input video signal Vid-in is not corrected based on the positional information RE2 (N), the correction unit 38 outputs the input video signal Vid-in as the output video signal Vid-out2 as it is.

According to the configuration described above, in a case in which a 3D video is displayed, the video processing circuit 30A outputs the output video signal Vid-out1 that is corrected by the correction unit 33 to the D/A conversion unit 34, and in a case in which a 2D video is displayed, the video processing circuit 30A outputs the output video signal Vid-out2 that is corrected by the correction unit 38 to the D/A conversion unit 34. In addition to the control, the switching control unit 35 may perform a control of selectively operating a first circuit block that is configured by the delay circuit 31, the boundary detection unit 32, and the correction unit 33, and a second circuit block that is configured by the delay circuit 36, the boundary detection unit 37, and the correction unit 38.

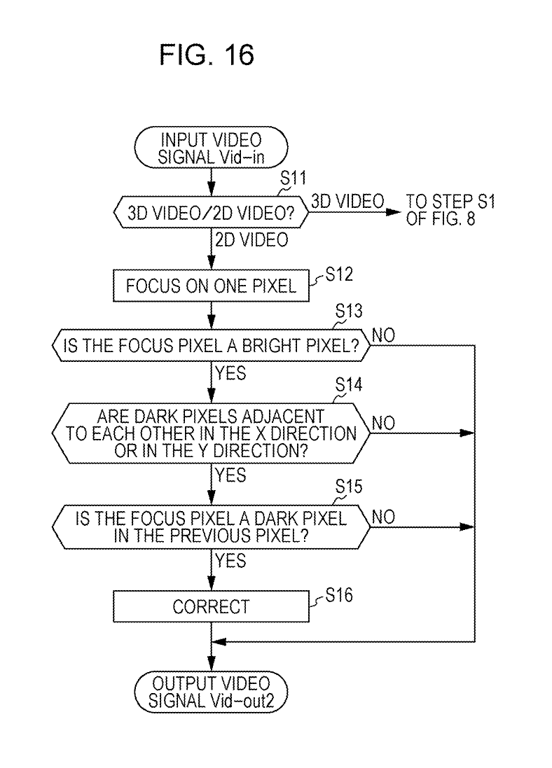

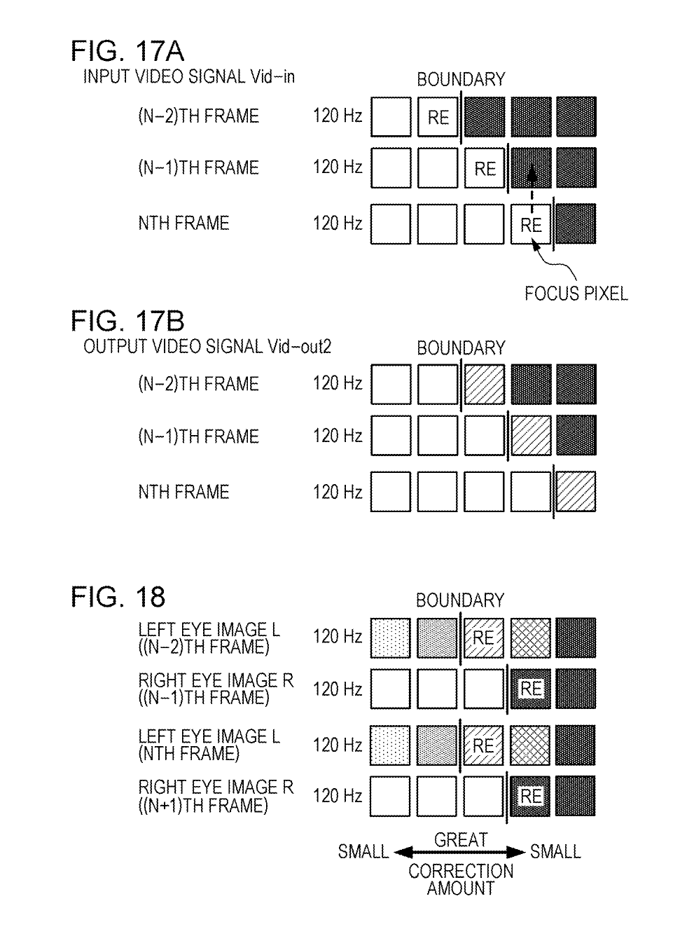

FIG. 16 is a flow chart illustrating a flow of video processing that is performed by the image processing circuit 30A. FIGS. 17A and 17B are diagrams illustrating specific examples of the video processing that is performed by the image processing circuit 30A.

To begin with, the image processing circuit 30A determines whether the input video signal Vid-in indicates a 3D video or a 2D video (step S11). In a case in which it is determined that the input video signal Vid-in indicates a 3D video (step S11; 3D video), the image processing circuit 30A proceeds to step S1 of FIG. 8. The video processing in a case of displaying a 3D video may be the same as the first embodiment described above, and here, description thereof will be omitted.

In a case in which it is determined that the input video signal Vid-in indicates a 2D video (step S11; 2D video), the image processing circuit 30A focuses on one pixel based on the input video signal Vid-in, and the one pixel is referred to as a focus pixel (step S12). Next, the image processing circuit 30A determines whether or not the focus pixel is a bright pixel (step S13).

In a case in which it is determined that the focus pixel is not a bright pixel, that is, is a dark pixel (step S13; NO), the image processing circuit 30A sets the input video signal Vid-in as an output video signal Vid-out2, converts the signal into the data signal Vx, and outputs the data signal Vx.

In a case in which it is determined that the result is “YES” in the processing of step S13, the image processing circuit 30A determines whether or not the dark pixels are adjacent to each other in the X direction (right direction) or in the Y direction (bottom direction) when viewing from the bright pixel that is the focus pixel (step S14).

Here, as illustrated in FIG. 17A, a case is considered in which a bright pixel moves by one pixel per frame in the X direction in the sequence of an (N−2)th frame, an (N−1)th frame, and an Nth frame, by using a dark pixel as a background. In this case, when the bright pixel that is denoted by “RE” is a focus pixel, the video processing circuit 30A determines that the result of step S14 is “YES”. In a case in which it is determined that the result of step S14 is “NO”, the video processing circuit 30A sets the input video signal Vid-in as the output video signal Vid-out2, converts the signal into the data signal Vx, and outputs the data signal Vx.

If it is determined that the result of step S14 is “YES” and a bright pixel adjacent to a dark pixel is specified, the video processing circuit 30A determines whether or not the dark pixel exists in the previous frame in a position in which the bright pixel exists (step S15). Here, in a case in which the Nth frame is set as the current frame and the bright pixel denoted by “RE” is specified, the video processing circuit 30A determines that the result of step S15 is “YES”. In a case in which it is determined that the result of step S15 is “YES”, the video processing circuit 30A determines the pixel of a correction target, based on the specified bright pixel, and corrects the input video signal Vid-in in the current frame (step S16). Then, the video processing circuit 30A sets the corrected video signal as the output video signal Vid-out2, converts the signal into the data signal Vx, and outputs the data signal Vx. A method of determining the pixel of a correction target and a method of determining an application voltage after the correction may be the same as step S5, and here, description thereof will be omitted.

For example, in a case in which a dark pixel is set as a correction target, the video processing circuit 30A corrects the video signal of a dark pixel to the video signal that designates an application voltage CV_L, as illustrated in FIG. 17B. Then, the video processing circuit 30A sets the corrected video signal as the output video signal Vid-out2, converts the signal into the data signal Vx, and outputs the data signal Vx.

In a case in which it is determined that the focus pixel is not a dark pixel in the previous frame, that is, is a bright pixel in the processing of step S15, the video processing circuit 30A determines that the result of the processing of step S15 is “NO”. In this case, the video processing circuit 30A sets the input video signal Vid-in as the output video signal Vid-out2, converts the signal into the data signal Vx, and outputs the data signal Vx.

As described above, in a case in which a 2D video is displayed on the liquid crystal panel 100, the video processing circuit 30A corrects the input video signal Vid-in in such a manner that it is difficult for a tailing phenomenon caused by the moving image domain to be made. According to this, the video processing circuit 30A can suppress display abnormality caused by the reverse tilt domain, also in a case in which one of a 3D video and a 2D video is displayed.

In the present embodiment, a case in which the video processing circuit 30A individually includes a first circuit block for suppressing an afterimage domain and a second circuit block for suppressing a moving image domain is described, but each element that configures the first circuit block may selectively perform the video processing for suppressing the afterimage domain and the video processing for suppressing the moving image domain.

### Modification Examples

The invention can be realized by embodiments different from the embodiments described above. In addition, modification examples described below may be appropriately combined with each other. Hereinafter, the video processing circuits 30 according to the first and second embodiments described above and the video processing circuit 30A according to the third embodiment described above are collectively referred to as a “video processing circuit 30”.

### Modification Example 1

In a case in which the number of correction processing is equal to or greater than “2”, the video processing circuit 30 may increase an amount of correction up to approximately the pixels close to a boundary between a dark pixel and a bright pixel. For example, in a case in which a dark pixel and a bright pixel are set as a correction target and the number of correction processing of each is set to “2”, the video processing circuit 30 performs video processing illustrated in FIG. 18. That is, with regard to a dark pixel, the video processing circuit 30 increases an amount of correction for increasing an application voltage up to the pixels close to a boundary between a dark pixel and a bright pixel, and decreases an amount of correction for decreasing an application voltage up to the pixels far from a boundary between a dark pixel and a bright pixel. In addition, with regard to a bright pixel, the video processing circuit 30 increases an amount of correction for decreasing an application voltage up to the pixels close to a boundary between a dark pixel and a bright pixel, and decreases an amount of correction for increasing an application voltage up to the pixels far from a boundary between a dark pixel and a bright pixel. According to this, the video processing circuit 30 can correct a video signal with an amount of correction in which an easy generation of a reverse tilt domain is considered.

### Modification Example 2

In the respective embodiments described above, the video processing circuit 30 determines whether or not a bright pixel exists in the previous frame, in a position in which a dark pixel exists in the current frame.

However, when a right eye image in the subsequent frame is displayed (for example, (N+1)th frame of FIG. 22B), an afterimage domain is generated. Thus, the video processing circuit 30 may determine whether or not a bright pixel exists in the subsequent frame, in a position in which a dark pixel exists in the current frame. The subsequent frame is an example of a frame adjacent to the current frame on the time axis.

For example, the video processing circuit 30 further includes a frame memory that stores the input video signal Vid-in in the current frame, and performs video processing for suppressing an afterimage domain, based on the input video signal Vid-in in the current frame which is read from the frame memory and the input video signal Vid-in in the subsequent frame which is supplied subsequently. The video processing in this case is described in the respective embodiments described above, and may be video processing in which a video signal in the previous frame is replaced with a video signal in the subsequent frame.

However, the determination unit 322 of the video processing circuit 30 determines whether or not a bright pixel exists in a first field in the subsequent frame, in a position of a dark pixel in one field of the current frame. The first field in the subsequent frame is a field, which is closest to each field of the current frame on the time axis, in the subsequent frames.

According to the video processing circuit 30 of the modification example, for example, in a case in which a 2D video is displayed, and even in a case in which conditions that an afterimage domain is generated are met, it is possible to suppress the generation of a reverse tilt domain.

### Modification Example 3

In the respective embodiments described above, an example in which a VA method is used for the liquid crystal 105 is described, but a twisted nematic (TN) method may be used, and the respective liquid crystal elements 120 may be set to a normally white mode which is in a white state when a voltage is not applied.

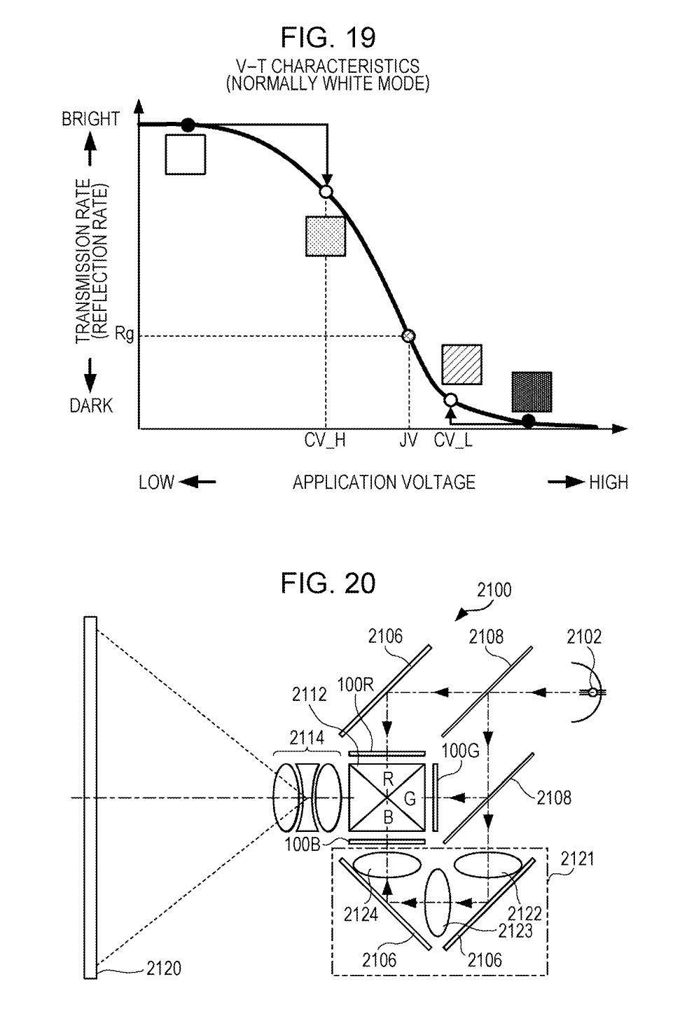

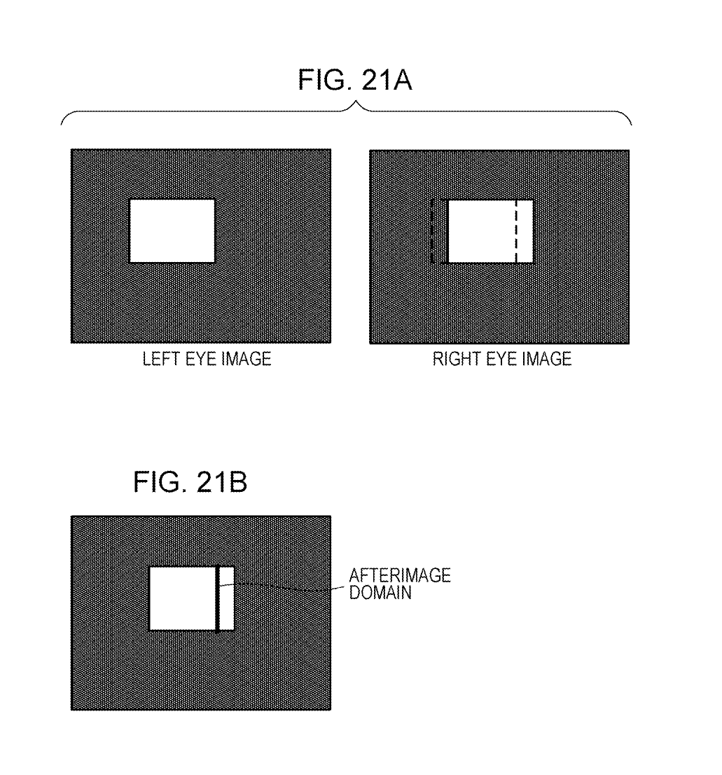

FIG. 19 is a graph illustrating a relationship (V-T characteristics) between an application voltage that is designated to the pixel 110 and a transmission rate of the liquid crystal element 120 that is included in the pixel 110, in a normally white mode. In the graph illustrated in FIG. 19, a horizontal axis denotes an application voltage that is designated to the pixel 110, and a vertical axis denotes a transmission rate (specifically, transmission rate) of the liquid crystal element 120.

As illustrated in FIG. 19, in the normally white mode, the lower the application voltage to the pixel 110 is, the greater the transmission rate (or reflection rate) of the pixel 110 is. For this reason, in the normally white mode, for example, the pixel 110 in which an application voltage designated to the pixel 110 is equal to or lower than the threshold voltage JV becomes a bright pixel (second pixel), and the pixel 110 in which an application voltage is higher than the threshold voltage JV becomes a dark pixel (first pixel).

In the video processing that is performed in the video processing circuit 30, in a case of the liquid crystal panel 100 in the normally white mode, a relationship between a voltage applied to the liquid crystal element 120 of the pixel 110 and a transmission rate is the reverse of a case of the liquid crystal panel 100 in the normally black mode, and the lower the transmission rate (or reflection rate) is, the higher a voltage to be applied to the liquid crystal element 120 is. However, except for this point, the video processing circuit 30A may perform video processing that is the same as that of the respective embodiments described above.

### Modification Example 4

A dark pixel and a bright pixel may not be defined by the conditions described in the respective embodiments described above. For example, a pixel whose application voltage designated to the pixel 110 is equal to or lower than a threshold that is previously determined may be set as a dark pixel, and a pixel whose application voltage designated to the pixel 110 is equal to or higher than a threshold that is greater than the threshold may be set as a bright pixel (in a case of a normally black mode). That is, a dark pixel and a bright pixel are two pixels adjacent to each other, and may be defined by a combination of the pixel 110 to which a certain application voltage is designated and the pixel 110 to which an application voltage higher than the application voltage is designated.

The configurations of both the video processing circuit 30 described in FIG. 7 and the video processing circuit 30A described in FIG. 15 are just an example, and for example, may be realized by a circuit in which two or more blocks are integrated, or may be realized by a circuit in which a partial block is omitted.

In addition, the specific numeric values described in the embodiments described above are just an example.

In addition, the sequence of the processing described in the embodiments described above may be appropriately replaced with others.

In addition, the liquid crystal panel 100 is not limited to a transmission type, and for example, may be a reflection type.

### Electronic Apparatus

As an example of an electronic apparatus that uses the electro-optical device 1 according to the respective embodiments described above, a projection type display device (projector) that uses the liquid crystal panel 100 as a light valve (that is, an optical modulator) will be described. FIG. 20 is a plan view illustrating a configuration of the projector.

As illustrated in FIG. 20, a lamp unit 2102 that is configured by a white light source such as a halogen lamp is provided in the inside of the projector 2100. Projection light that is emitted from the lamp unit 2102 is divided into three primary colors of R color, G color, and B color by three mirrors 2106 and two dichroic mirrors 2108 which are disposed in the inside of the projector 2100, and are respectively guided to light valves 100R, 100G, and 100B which correspond to the respective primary colors. The light of B color has a longer light path than those of the other lights of R color and G color, and thus, being guided via a relay lens system 2121 that is configured by an incident lens 2122, a relay lens 2123, and a emitting lens 2124, in order to prevent loss thereof.

Three sets of the electro-optical device 1 that includes the liquid crystal panel 100 are provided in the projector 2100 in correspondence to each of the R color, the G color, and the B color. The configurations of the light valves 100R, 100G, and 100B are the same as that of the liquid crystal panel 100 described above. Video signals with primary color components of each of the R color, the G color, and the B color are respectively supplied from an external higher level circuit, and thereby, the light valves 100R, 100G, and 100B are configured to be respectively driven.

The lights that are respectively modulated by the light valves 100R, 100G, and 100B are incident on the dichroic prism 2112 from three directions. Then, the lights of R color and B color are refracted by 90 degrees in the dichroic prism 2112, and meanwhile the light of G color goes straight. Thus, images of the respective primary colors are synthesized, and thereafter, a color image is projected onto a screen 2120 by the projection lens 2114.

The lights that correspond to each of the R color, the G color, and the B color are incident on the light valves 100R, 100G, and 100B by the dichroic mirrors 2108, and thus, it is not necessary to provide a color filter. In addition, images that transmit the light valves 100R, and 100B are reflected by the dichroic prism 2112, and thereafter are projected. In contrast to this, an image that transmits the light valve 100G is projected as it is, and thus, a horizontal scan direction determined by the light valves 100R and 100B becomes a reverse direction to a horizontal scan direction determined by the light valve 100G, and an image obtained by inverting the left and the right is displayed.

In addition to the projector described with reference to FIG. 20, a television, a view finder type or monitor direct view type video tape recorder, a car navigation device, a pager, an electronic organizer, an electronic calculator, a word processor, a workstation, a television phone, a POS terminal, a digital still camera, a cellular phone, an apparatus including a touch panel, or the like is used as the electronic apparatus. Thus, the electro-optical device 1 can be applied to these various electronic apparatuses.

The entire disclosure of Japanese Patent Application No. 2014-222472, filed Oct. 31, 2014 is expressly incorporated by reference herein.

What is claimed is:

1. A video processing circuit that defines a gradation which is displayed in each of a plurality of pixels, based on a video signal which designates an application voltage to the respective pixels of an optical modulator including the plurality of pixels, comprising:
a specific unit that specifies a first pixel adjacent to a second pixel which displays a higher gradation than a predetermined gradation, among the first pixels which display gradations equal to or lower than the predetermined gradation, based on the video signal in a current frame;
a determination unit that determines whether or not the second pixel exists in a frame adjacent to the current frame, in a position of the first pixel which is specified, based on the video signal of the frame adjacent to the current frame on the time axis;
a correction unit that, in a case in which it is determined that the second pixel exists in the frame adjacent to the current frame, corrects the video signal in the current frame, in such a manner that a difference of an application voltage between the specified first pixel and the second pixel adjacent to the first pixel is reduced; and
an output unit that outputs a signal according to the corrected video signal to a drive circuit which drives the optical modulator based on the signal.

2. The video processing circuit according to claim 1,
wherein the video signal displays a 3D video that alternately switches a left eye image and a right eye image in each frame, and
wherein the determination unit determines whether or not the second pixel exists in a frame before one frame of the current frame, in a position of the specified first pixel.

3. The video processing circuit according to claim 1, wherein the determination unit determines whether or not the second pixel exists in a frame after one frame of the current frame, in a position of the specified first pixel.

4. The video processing circuit according to claim 1, wherein the correction unit sets a pixel to which a lower application voltage that is designated by the video signal in the current frame is applied, among the specified first pixel and the second pixel adjacent to the first pixel, as a correction target.

5. The video processing circuit according to claim 1, wherein the correction unit sets the specified first pixel and the second pixel adjacent to the first pixel, as a correction target.

6. The video processing circuit according to claim 1,
wherein the plurality of pixels is provided in correspondence to each of intersections of a plurality of scan lines extending in a first direction and a plurality of data lines extending in a second direction,
wherein the drive circuit selects the plurality of scan lines on a per K (K is an integer equal to or greater than 2) piece basis, and applies a designated voltage to the pixel corresponding to one of the K scan lines, and
wherein, in a case in which the specified first pixel and the second pixel adjacent to the first pixel are adjacent in the first direction, the correction unit sets P (however, P is a natural number equal to or greater than 2) pixels that are consecutive in the first direction from a boundary interposed between the first pixel and the second pixel as a correction target, and in a case in which the specified first pixel and the second pixel adjacent to the first pixel are adjacent in the second direction, the correction unit sets Q (however, Q is a natural number smaller than P) pixels that are consecutive in the second direction from the boundary as a correction target.

7. The video processing circuit according to claim 1, wherein, in a case in which two or more pixels that are consecutive in a direction separated from a boundary between the specified first pixel and the second pixel adjacent to the first pixel are set as a correction target, the correction unit increases an amount of correction as much as the pixels close to the boundary.

8. The video processing circuit according to claim 1,
wherein the drive circuit divides one frame into a plurality of fields, and applies a voltage according to the corrected video signal to the pixels in the respective fields that are divided, and
wherein the determination unit determines whether or not the second pixel exists in a field closest to one field of the frame adjacent to the current frame on the time axis, in a position of the first pixel in one field of the current frame.

9. The video processing circuit according to claim 1,
wherein, in a case in which the video signal indicates a 3D video in which a left eye image and a right eye image are alternately switched in each frame, the output unit outputs a signal according to the corrected video signal to the drive circuit,
wherein, in a case in which the video signal displays a 2D video, a third pixel adjacent to a fourth pixel to which the application voltage equal to or lower than the predetermined voltage is applied among the third pixels to which the application voltage higher than the predetermined voltage is applied is specified based on the video signal in the current frame, and whether or not the fourth pixel exists in a frame before one frame of the current frame is determined in a position of the specified third pixel based on the video signal in the frame before one frame of the current frame,
wherein, in a case in which it is determined that the fourth pixel exists in the frame before one frame of the current frame, the video signal in the current frame is corrected in such a manner that a difference of the application voltage between the specified third pixel and the fourth pixel adjacent to the third pixel is reduced, and
wherein a signal according to the corrected video signal is output to the drive circuit.

10. A video processing method that defines a gradation which is displayed in each of a plurality of pixels, based on a video signal which designates an application voltage to the respective pixels of an optical modulator including the plurality of pixels, comprising:
specifying a first pixel adjacent to a second pixel which displays a higher gradation than a predetermined gradation, among the first pixels which display gradations equal to or lower than the predetermined gradation, based on the video signal in a current frame;
determining whether or not the second pixel exists in a frame adjacent to the current frame, in a position of the first pixel which is specified, based on the video signal of the frame adjacent to the current frame on the time axis;
correcting the video signal in the current frame, in such a manner that a difference of an application voltage between the specified first pixel and the second pixel adjacent to the first pixel is reduced, in a case in which it is determined that the second pixel exists in the frame adjacent to the current frame; and
outputting a signal according to the corrected video signal to a drive circuit which drives the optical modulator.

11. An electro-optical device comprising:
an optical modulator including the plurality of pixels;
a video processing circuit that defines a gradation which is displayed in each of a plurality of pixels, based on a video signal which designates an application voltage to the respective pixels of the optical modulator, including
a specific unit that specifies a first pixel adjacent to a second pixel which displays a higher gradation than a predetermined gradation, among the first pixels which display gradations equal to or lower than the predetermined gradation, based on the video signal in a current frame,
a determination unit that determines whether or not the second pixel exists in a frame adjacent to the current frame, in a position of the first pixel which is specified, based on the video signal of the frame adjacent to the current frame on the time axis, and
a correction unit that, in a case in which it is determined that the second pixel exists in the frame adjacent to the current frame, corrects the video signal in the current frame, in such a manner that a difference of an application voltage between the specified first pixel and the second pixel adjacent to the first pixel is reduced; and
a drive circuit that drives the optical modulator in accordance with the corrected video signal.

12. An electronic apparatus comprising:
the electro-optical device according to claim 11.
